(19) United States
(12) Patent Application Publication
(10) Pub. No.: US 2020/0285528 A1
(43) Pub. Date: Sep. 10, 2020

(54) APPLICATION PROGRAM INTERFACE LISTS

(71) Applicant: Hewlett Packard Enterprise Development LP, Houston, TX (US)

(72) Inventor: Jesse D. Olsen, Ft. Collins, CO (US)

(21) Appl. No.: 16/292,553

(22) Filed: Mar. 5, 2019

(51) Int. Cl. G06F 9/54; G06F 16/9032; G06F 17/27; G06F 16/903

(52) U.S. Cl. CPC G06F 9/541; G06F 16/90344; G06F 17/2705; G06F 16/90332

(57) ABSTRACT

In some examples, a system may include a processing resource and a memory resource storing machine-readable instructions to cause the processing resource to compare an input, received at a chatbot, to language features declared in a documentation configuration reference of a first API, in a first list of APIs integrated locally to a computing device executing the chatbot, to determine whether the first API supports the input; compare, responsive to a determination that the input is not supported by the first API, the input to language features declared in a documentation configuration reference of a second API, in a second list of APIs integrated remotely from the computing device executing the chatbot, to determine whether the second API supports the input; and add, responsive to a determination that the input is supported by the second API, the documentation configuration reference of the second API to the first list of APIs.

### BACKGROUND

A chatbot may include an application that simulates a conversation with users. The chatbot may provide a service to a user and communicate in a conversational style with the user in providing the service. The chatbot may accept natural language text and/or voice inputs from the user. The chatbot may generate and output natural language text and/or voice output to the user. The chatbot may be architecturally and functionally separate from other applications but the chatbot may be utilized to interface with the other applications.

### BRIEF DESCRIPTION OF THE DRAWINGS

FIG. 1 illustrates an example of a system implementable with API list utilization consistent with the present disclosure.

FIG. 2 illustrates an example of a system implementable with API list utilization consistent with the present disclosure.

FIG. 3 illustrates an example of a system implementable with API list utilization consistent with the present disclosure.

FIG. 4A illustrates an example of a system of API list utilization consistent with the present disclosure.

FIG. 4B illustrates an example of a system of API list utilization consistent with the present disclosure.

FIG. 5 illustrates an example of a non-transitory machine-readable memory resource and processing resource of API list utilization consistent with the present disclosure.

FIG. 6 illustrates an example of a method of API list utilization consistent with the present disclosure.

### DETAILED DESCRIPTION

A chatbot may be utilized to provide a service to a user. The chatbot may be a stand-alone application that utilizes and/or interfaces with other applications to provide the service to the user. A chatbot may include non-transitory machine-readable instructions executable by a processor to provide the service to the user. The chatbot instructions may be separate and stand apart from instructions of the applications that the chatbot utilizes and/or interfaces with to provide the service to the user.

A chatbot may interface with an application. For example, a chatbot may be utilized to communicate with an application programming interface (API) of an application that is distinct from the chatbot. In some examples, the chatbot may perform communications such as issue commands to a separate application and/or receive outputs from a separate application. As such, a chatbot may be configured to communicate with an API of a separate application.

The chatbot may operate as a component of or as a stand-alone digital assistant. For example, the chatbot may function to convert user input to the chatbot into commands to an API of a separate application. The chatbot may also communicate outputs from the API of the separate application to the chatbot user through the chatbot interface, such as a web chat application interface visible to users.

However, chatbots may be configured to communicate in a conversational style with their users. For example, chatbots may be configured to accept natural language text and/or voice inputs from a user and/or output data to the user in an approximation of a natural language format. In contrast, the separate applications that the chatbot interfaces with to send and/or receive data associated with performing digital assistant functionalities on behalf of the user may not respond to and/or understand communications and/or commands in a natural language format.

In order to facilitate chatbot communication with a separate application, the chatbot will be hardcoded with instructions executable to perform the specific communications with the specific separate application. For example, a chatbot may be extended with a software developer kit (SDK) such as a library of code added to the chatbot that specifies regular expressions that may be identified in the input to the chatbot along with the corresponding objects and commands that should be generate by the chatbot in order to effectuate an operation or response at the specific separate application. In order to communicate with multiple separate applications, the chatbot may be extended with multiple different libraries each corresponding to a separate API. As such, each additional API and/or each new API that it may be desired for the chatbot to communicate with may involve an additional extension and/or update of the chatbot.

In contrast, examples of the present disclosure may include chatbots that may be able to receive and transform regular language inputs received from a user to actionable outputs understandable by a plurality of different APIs without a corresponding plurality of extensions to the chatbot hard coding in such transformations to the chatbot. Likewise, examples of the present disclosure may be able to transform outputs from the API into natural language outputs presentable to the user by the chatbot, again without the corresponding plurality of extensions to the chatbot hard coding in such transformations to the chatbot. For example, examples of the present disclosure may parse a documentation configuration reference of an API to find a match between language features in an input and language features declared in the documentation configuration reference to determine that the API supports the input and/or to execute an action according to a mapping declared by the documentation configuration reference of the API as corresponding to the matching language feature.

As described above, the chatbot may interface with a plurality of APIs. Some of the APIs may be integrated locally to a computing device that is executing the chatbot. Alternatively, some of the APIs may be integrated remotely from the computing device executing the chatbot.

When the chatbot receives the input, it may begin the comparison between the input and the documentation configuration references of the various APIs. However, iteratively parsing the documentation configuration reference of each of a plurality of APIs may consume computational resources and/or time proportional to the amount of APIs being assessed. As such, parsing the documentation configuration reference of a relatively large quantity of APIs may consume a correspondingly large quantity of computational resources and/or time to complete. However, a chatbot may typically utilize a relatively smaller portion of the plurality of APIs on a regular basis. In such examples, the chatbot may be repeatedly consuming computational resources and time parsing the documentation configuration reference of APIs that it does not typically utilize each time it receives an input.

In contrast, examples of the present disclosure may include a system for constructing, maintaining, and/or utilizing a local API documentation configuration reference cache local to the chatbot to reduce the amount of API documentation configuration references to be initially parsed responsive to each input. The system may include a global registry of API documentation configuration references remote from the chatbot, which may be utilized, when the local cache does not support the input, to execute the input and/or modify the local cache of API documentation configuration references.

For example, examples of the present disclosure may include a system including a processor and a memory resource. The memory resource may store machine-readable instructions to cause the processor to perform various functionalities. For example, the instructions may be executable by the processing resource to compare an input, received at a chatbot, to language features declared in a documentation configuration reference of a first API, in a first list of APIs integrated locally to a computing device executing the chatbot, to determine whether the first API supports the input; compare, responsive to a determination that the input is not supported by the first API, the input to language features declared in a documentation configuration reference of a second API, in a second list of APIs integrated remotely from the computing device executing the chatbot, to determine whether the second API supports the input; and add, responsive to a determination that the input is supported by the second API, the documentation configuration reference of the second API to the first list of APIs integrated locally to the computing device executing the chatbot.

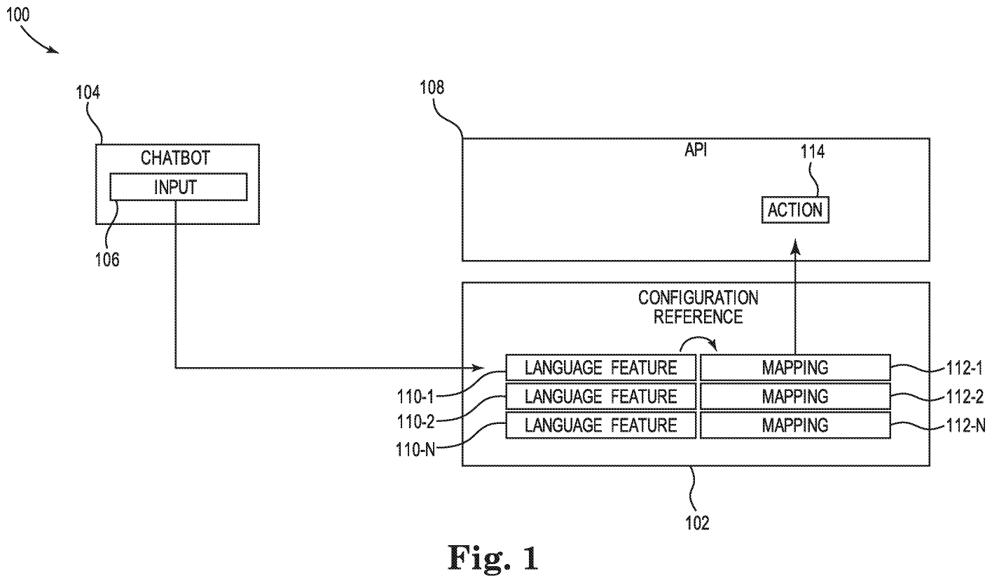

FIG. 1 illustrates an example of a system 100 implementable with API list utilization consistent with the present disclosure. The system 100 may include a chatbot 104. The chatbot 104 may provide a digital assistant service to a user. The chatbot 104 may include instructions executing on a computing device accessible via a web application. For example, a user may access the chatbot 104 and/or utilize its services via user interface presented to the user via a web application presented on a user's computing device.

The chatbot 104 may accept input 106 from a user. The input 106 may be text and/or voice fed into the user interface of the chatbot 104 from a user. The chatbot 104 may be configured to communicate with the user in a conversational manner. For examples, the chatbot 104 may accept input 106 in a natural language format and/or generate outputs to the user in a natural language format. For example, a user may type or speak information to the chatbot 104 formatted in human language of whichever dialect the user is familiar with. In examples, the input 106 may be structured in sentence form. That is, in contrast to a constructed or formal language such as those used to program computers or to study logic, an input 106 may be structured as an English language command, instruction, request, question, etc. written or spoken in a natural ordinary human language.

In an example, the input 106 may include a natural language expression of an instruction to the chatbot 104 to perform a functionality on behalf of the user. In this manner, the chatbot 104 may serve in a digital assistant capacity. For example, the input 106 may include a sentence such as “show me everyone's phone number on the project A team.” However, the chatbot 104 may not be the application and/or a component of the application that has access to the data and/or services being requested by the user. For example, the chatbot 104 may be a stand-alone digital assistant that is not part of the APIs that the user is requesting in their input 106 to be accessed and/or manipulated.

In an example, a user may be an information technology (IT) specialist for a company. The user may desire to utilize the chatbot 104 to interface with project management APIs, cloud management platform APIs, blade enclosure management APIs, etc. The chatbot 104 may be a separate generic chatbot that may not be a component of any of the APIs. However, the input 106 from the user to the chatbot 104 may implicate data to be retrieved from, a command to be issued to, a functionality to be performed by, etc. the separate APIs. For example, the “show me everyone's phone number on the project A team” input 106 may be a natural language expression tantamount to a command to the chatbot 104 to communicate with the project management API and retrieve everyone's phone number on the project A team from that API and present it to the user. However, chatbot 104 may not include a hard-coded extension serving as a library at the chatbot 104 that, when referenced, provides the chatbot 104 with the instructions utilizable to communicate the intent of the input 106 to the project management API in a format understandable to and/or actionable by the project management API.

As described above, the system 100 may include an API 108. The API 108 may include a single API and/or a plurality of APIs. The API 108 may include instructions executable by a processing resource to receive requests and/or send responses from an underlying application and/or group of resources. The API 108 may include instructions executable to facilitate communication between two systems by providing a language and/or contract for how two systems interact.

The API 108 may be separate and/or stand-alone from the chatbot 104. For example, the API 108 may be a project management API, a cloud management platform API, blade enclosure management API, etc. The API 108 may control and set the terms of access to underlying resources related to project management, a cloud management platform, blade enclosure management, etc. While a chatbot 104 may utilize the API 108 to interface with said resources, the chatbot 104 may be functionally and/or architecturally distinct from the API 108 and the underlying resources.

The API 108 may include instructions, separate from the chatbot 104 instructions, stored and/or executed on a same computing device and/or virtualized hardware unit as is storing and/or executing the chatbot 104 instructions. In some examples, the API 108 may include instructions stored and/or executed on a different computing device and/or virtualized hardware unit as is storing and/or executing the chatbot 104 instructions.

The API 108 may include a configuration reference 102. A configuration reference 102 may include a computing file specifying the configuration of the API 108 and its use. For example, the configuration reference 102 may include a component of, provided by, and/or associated with the API 108 that is accessible to and/or readable by users and/or the chatbot 104.

The configuration reference 102 may include instructions, separate from the chatbot 104 instructions, stored and/or executed on a same computing device and/or virtualized hardware unit as is storing and/or executing the chatbot 104 instructions. In some examples, the configuration reference 102 may include instructions stored and/or executed on a different computing device and/or virtualized hardware unit as is storing and/or executing the chatbot 104 instructions.

For example, the configuration reference 102 may be a portion of an API's documentation file. The API documentation configuration reference 102 may include documentation that serves as a reference manual for the API 108. The API documentation configuration reference 102 may communicate to API consumers how to utilize the API 108. The API documentation configuration reference 102 may be structured for consumption by humans. The API documentation configuration reference 102 may provide examples of every call, every parameter, and responses for each call for the API 108. The API documentation may include code samples for commonly used languages such as, for example, Java, JavaScript, PHP, Python, etc. API documentation may provide explanations for each API request and examples of error messages. The API documentation may communicate functional knowledge of the API 108. That is, the API documentation may include an explanation of how an API 108 functions and how to call those functions. The API specification may detail the functional and expected behavior of the API as well as the fundamental design philosophy and supported data types. An API definition may be similar to an API specification in that it provides an understanding of how an API is organized and how the API functions. However, the API definition may be structured for machine consumption instead of human consumption and may provide information about how the API functions, how it links with other APIs, and the expected results in a machine-readable format.

Documentation configuration references 102 may include an OpenAPI configuration file (e.g., Swagger) or some other configuration file. The documentation configuration reference 102 may include information that may be utilized as a map of how the API 108 is organized and/or functions for reference by developers developing against it. The documentation configuration reference 102 may be structured in a variety of formats. For example, the documentation configuration reference 102 may be structured to include OpenAPI definitions in YAML or JSON, however examples are not so limited.

The documentation configuration reference 102 may include information such as title, description, and version information for the API 108. The documentation configuration reference 102 may include information such as the API server and/or base URL for the API 108. The documentation configuration reference 102 may include API paths relative to the server URL for the API 108. For example, the documentation configuration reference 102 may include information that defines individual endpoints and/or paths to endpoints of the API 108 and/or the HTTP (or other standard) methods or operations supported by the endpoints. The operations may be defined by information including parameters, request body, if any, possible response status codes, response contents, etc. The operations may have parameters passed via URL path, query string, headers, cookies, etc. The documentation configuration reference 102 may include information including input and output models described with global components/schemas for common data structures utilized in the API 108 that can be references whenever a schema is to be utilized. The documentation configuration reference 102 may include security schemas and security keywords that may be used to describe the authentication methods utilized in the API 108.

Examples of the present disclosure may extend and/or transform existing documentation configuration references 102. For example, the documentation configuration reference 102 of an API 108 may be modified. The documentation configuration reference 102 of API 108 may be modified to include language feature identifiers 110-1 . . . 110-N. Language feature identifiers 110-1 . . . 110-N may include various mechanisms for identifying, translating, understanding, and/or matching structures or patterns present in natural language inputs. For example, the language feature identifiers 110-1 . . . 110-N may include natural language structures stored in the documentation configuration reference 102. That is, the language feature identifiers 110-1 . . . 110-N may include natural language structures or other machine-recognizable language patterns that may be compared to a natural language input to identify matching structures in the input. As such, the language feature identifiers 110-1 . . . 110-N may serve as a list of potential natural language structures which may appear in a natural language input, in order to contextualize and understand the information and/or intent that the user inputting the natural language input is attempting to communicate. The language feature identifiers 110-1 . . . 110-N may help make sense of a natural language input by identifying structures or patterns that may be associated with different meanings or commands.

Examples of a language feature identifiers 110-1 . . . 110-N may include regular expressions. For example, a regular expression may include specialized notations for describing language patterns that may be matched and/or identified in a natural language input 106. The regular expression may include characters, strings of characters, punctuation, wildcard symbols, alternatives symbols, group strings, forced match symbols, optionality symbols, character range symbols, etc. that describe language patterns that may be matched and/or identified in a natural language input 106.

The language feature identifiers 110-1 . . . 110-N may be utilized as a catalog of characters or other linguistic structure that, when matched to a portion of the natural language input 106, may identify or categorize a meaning or context of the natural language input 106. Again, these language feature identifiers 110-1 . . . 110-N may be stored as a portion of the documentation configuration reference 102 of the API 108. That is, in contrast to other chatbots which may include regular expression catalogs as libraries that are extension of the instructions or code of the chatbot itself, the language feature identifiers 110-1 . . . 110-N may be a component of the documentation configuration reference 102 and/or the API 108.

In addition to the language feature identifiers 110-1 . . . 110-N, the documentation configuration reference 102 may include mappings 112-1 . . . 112-N. The mappings 112-1 . . . 112-N may correspond to a portion of the language feature identifiers 110-1 . . . 110-N. For example, a first mapping 112-1 may correspond to a first language feature identifier 110-1 . . . 110-N. Each mapping 112-1 . . . 112-N may describe an endpoint of the API 108, a path to the endpoint of the API 108, and/or an action or operation to be performed at the API 108. In some examples, each mapping 112-1 . . . 112-N may describe data associated with identifying and/or executing a REST call or REST command to the API 108.

Again, these mappings 112-1 . . . 112-N may be stored as a portion of the documentation configuration reference 102 of the API 108. That is, in contrast to other chatbots which may include objects created in the code of the chatbot itself that correspond to performance of actions at the API 108, the mappings 112-1 . . . 112-N may be a component of the documentation configuration reference 102 and/or the API 108.

As described above, the mappings 112-1 . . . 112-N may correspond to the language feature identifiers 110-1 . . . 110-N. In this manner, the documentation configuration reference 102 may include instructions to transform a natural language input 106 to a REST call without the expansion of the chatbot 104 instructions to include libraries with such information. However, to be utilized for such a purpose, the documentation configuration reference 102, and more specifically the language feature identifiers 110-1 . . . 110-N and their corresponding mappings 112-1 . . . 112-N may be exposed to the chatbot 104. As such, the chatbot 104 may be able to parse the documentation configuration reference 102 to identify or learn the language feature identifiers 110-1 . . . 110-N and their corresponding mappings 112-1 . . . 112-N for the API 108 that it is trying to communicate with on behalf of the user. In some example, the language feature identifiers 110-1 . . . 110-N and/or their corresponding mappings 112-1 . . . 112-N to the API resources may be set apart from the remainder of the documentation configuration reference 102.

For example, the language feature identifiers 110-1 . . . 110-N and/or their corresponding mappings 112-1 . . . 112-N to the API resources may be set apart from the body of the documentation configuration reference 102 by a symbol such that a human user and/or a computing device can identify and/or segregate the language feature identifiers 110-1 . . . 110-N and/or their corresponding mappings 112-1 . . . 112-N from the other information contained in the documentation configuration reference 102.

In some examples, the language feature identifiers 110-1 . . . 110-N and/or their corresponding mappings 112-1 . . . 112-N may be located in a portion of the documentation configuration reference 102 that is outside of a documentation tag. As such, the language feature identifiers 110-1 . . . 110-N and/or their corresponding mappings 112-1 . . . 112-N may not be visible to or accessible by a human user. However, the language feature identifiers 110-1 . . . 110-N and/or their corresponding mappings 112-1 . . . 112-N may be visible to computing devices and/or to the chatbot 104.

As such, in the system 100 a chatbot 104 may receive a natural language input 106 from a user. The chatbot 104 may parse the documentation configuration reference 102 of an API 108 that the input 106 is directed to, calls on, and/or implicates. In some examples, the chatbot 104 may process the input 106 to determine which API 108 the input 106 is directed to. In some examples, the chatbot 104 may infer from the content or context of the input 106 which API 108 the input 106 is directed to. In some examples, the chatbot 104 may prompt and/or receive an indication from the user directly indicating the API 108 that the input 106 is directed to. In some examples, the chatbot 104 may parse the documentation configuration reference 102 of a plurality of APIs to find a match to a language feature identifier 110-1 . . . 110-N in a particular one of the plurality of APIs that informs which API pf the plurality that the input 106 is directed to.

The chatbot 104 may parse the documentation configuration reference 102 of an API 108 that the input 106 is directed to in order to compare the natural language input 106 to the language feature identifiers 110-1 . . . 110-N declared in the documentation configuration reference 102. The chatbot 104 may parse the documentation configuration reference 102 of an API 108 to identify, for example, a regular expression or other language feature identifier 110-1 . . . 110-N that matches a portion of the natural language input 106.

The chatbot 104 may parse the documentation configuration reference 102 of an API 108 to identify a mapping 112-1 . . . 112-N that corresponds to the language feature identifiers 110-1 . . . 110-N that matches a portion of the natural language input 106. For example, the chatbot 104 may parse the documentation configuration reference 102 of an API 108 and identify that a first language feature identifier 110-1 matches a portion of the natural language input 106 that the user input to the chatbot 104. The chatbot 104 may parse the documentation configuration reference 102 of an API 108 and identify a first mapping 112-1 that corresponds to the first language feature identifier 110-1 matching a portion of the natural language input 106. For example, the chatbot may identify a first mapping 112-1 that declares an API path and an API operation corresponding to the first language feature identifier 110-1. The API path may specify an endpoint resource exposed by the API 108. The API operation may include an HTTP and/or non-HTTP method operation utilizable to access the API path.

The chatbot 104 may execute the action 114 declared in the first mapping 112-1 that corresponds to the first language feature identifier 110-1 that matches a portion of the natural language input 106. For example, the chatbot 104 may determine the URL or the path to an operation to be performed at an endpoint resource of the API 108 and may utilize the declared path to access the endpoint resource and execute the operation. The chatbot 104, in some examples, may not be relying on objects or libraries within its own instructions to identify regular expressions in the natural language input and/or to determine actions corresponding to those regular expressions. Instead, the chatbot 104 may be relying on a parsing of the documentation configuration reference 102 and, more specifically, the language feature identifiers 110-1 . . . 110-N and their corresponding mappings 112-1 . . . 112-N to determine how to connect, interface, and/or communicate with an API 108. As such, a chatbot 104 may be genericized insofar as the chatbot 104 may be able to communicate with an array of APIs and even new APIs without updating and/or extending the chatbot 104 instructions.

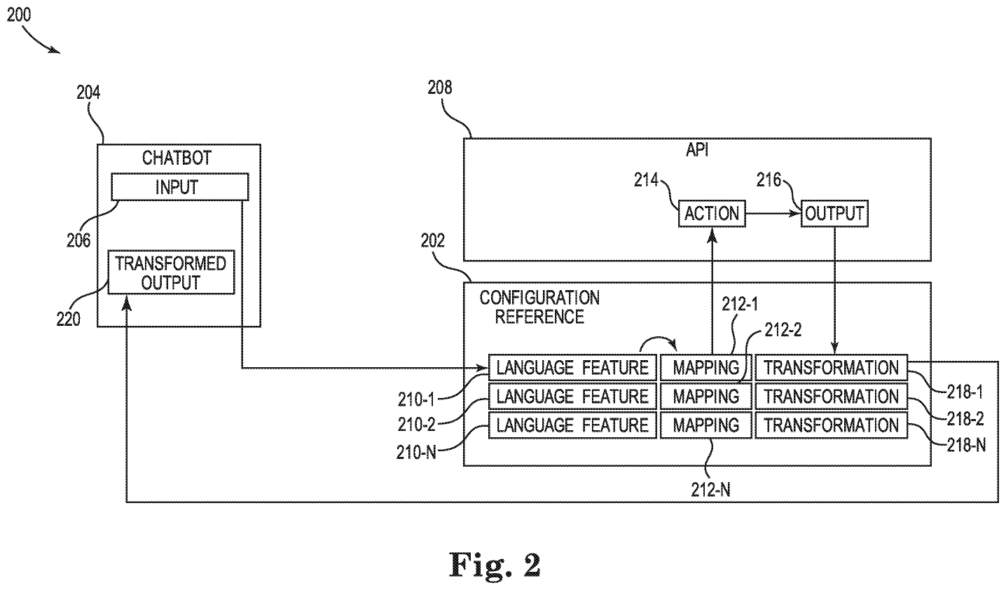

FIG. 2 illustrates an example of a system 200 implementable with API list utilization consistent with the present disclosure. The system 200 may include a chatbot 104. The chatbot 204 may receive an input 206 from a user. The input 206 may include a request to the chatbot 104 to perform a digital assistance and/or data discovery operation on behalf of the user with a separate API 208.

The chatbot 204 may parse a configuration reference 202 of the API 208 in order to determine language feature identifiers 210-1 . . . 210-N and their corresponding mappings 212-1 . . . 212-N to endpoints, paths, resources, operations, etc. of the API 208. The chatbot 204 may parse the configuration reference 202 of the API 208 in order to identify language feature identifiers 210-1 . . . 210-N declared in the configuration reference 202 that match a portion of the natural language input 206.

The chatbot 204 may execute an action 214 according to a mapping 212-1 . . . 212-N declared by the configuration reference 202 of the API 208 as corresponding to the regular expression that it identified as matching the portion of the natural language input 206. For example, the chatbot 204 may utilize a path to an endpoint resource to access the endpoint and execute an operation on the endpoint as specified by the mapping 212-1 . . . 212-N. The chatbot 204 may be initially uninformed of the correlation between its received natural language input 206 and a language feature identifier 110-1 . . . 110-N, such as a regular expression, recognized by the API 208. Likewise, the chatbot 204 may be initially uninformed of the correlation between the language feature identifier 210-1 . . . 210-N matching its input 206 and the corresponding mapping 212-1 . . . 212-N to an action 214 at the API 208. The chatbot 204 may not possess this data but may instead rely on the language feature identifier 210-1 . . . 210-N and their corresponding mappings 212-1 . . . 212-N stored in the configuration reference 202 of the API 208 which may allow the chatbot 204 to interface with multiple diverse APIs without expansion of the chatbot 204 instructions.

In some examples, the action 214 performed at the API 214 may generate an output 216. For example, an action 214 such as a data query of a database resource of an API 208 may generate an output 216 including the response to the query (e.g., the queried for data). However, the output 216 may be in a wide variety of formats. For example, the output 216 may be produced by the API 208 in a format that is native to and/or utilized by the API 208. The output 216 may not be in a format displayable by and/or understandable by the chatbot 204. Additionally, the output 216 may not be in a format displayable to or understandable by the user of the chatbot 204. In some examples, the output 216 may be formatted in a structured or hierarchical language that is difficult for a human user to easily understand. The output 216 may not be formatted in a natural language format that corresponds to and responds to the natural language input 206 in a natural language and/or conversational manner. For example, execution of the action 214 at the API 208 may return data in a JSON, HTML, and/or other hierarchical data format. As such, the display of the output 216 in such a format by the chatbot 204 to the user may not be useful, efficient, and/or expected by the human user of the chatbot 204.

However, in addition to mappings 212-1 . . . 212-N that correspond to the language feature identifiers 210-1 . . . 210-N, the configuration reference 202 may additionally include transformations 218-1 . . . 218-N that correspond to the language feature identifiers 210-1 . . . 210-N and/or mappings 212-1 . . . 212-N. A transformation 218-1 . . . 218-N may declare instructions to transform an output 216 generated by an action 214 performed according to a corresponding mapping 212-1 . . . 212-N which corresponded to a particular language feature identifier 210-1 . . . 210-N that matched a portion of an input 206.

For example, a transformation 218-1 . . . 218-N may declare instructions for changing the format of an output 216 to a format utilized by the chatbot 204 and/or the user. For example, a transformation 218-1 . . . 218-N may include instructions on converting the output 216 to a natural language format for communication by the chatbot 204 to the user in a conversational natural language format.

In some examples, the transformation 218-1 . . . 218-N for a particular language feature identifier 210-1 . . . 210-N and/or mapping 212-1 . . . 212-N may include instructions on how to transform the corresponding output 216 into a plurality of distinct formats (e.g., natural language, different dialects, different structure languages, different hierarchical languages, different file types, etc.). The particular transformation 218-1 . . . 218-N utilized to transform the output 216 may be determined by the chatbot 204, the user of the chatbot 204, and/or the format of the input 206 to the chatbot 204.

The chatbot 204 may transform the output 216 according to the transformation 218-1 . . . 218-N that corresponds to the mapping 212-1 . . . 212-N which corresponds to the language feature identifier 210-1 . . . 210-N that the chatbot 204 determined to match a portion of its input 206. The transformed output 220, including the data from the output 216 transformed into the specified format, may be presented to the user by the chatbot 204 via a user interface and/or audio output.

In some examples, creating the transformed output 220 may involve placing portions of the output 216 in an approximation of a natural language sentence addressed to the user. In some examples, creating the transformed output 220 may involve calculating and/or otherwise determining new data from the output 216 and/or placing the new data in an approximation of a natural language sentence addressed to the user. For example, creating the transformed output 220 may involve summing an amount of outputs and placing the sum in a natural language sentence addressed to the user.

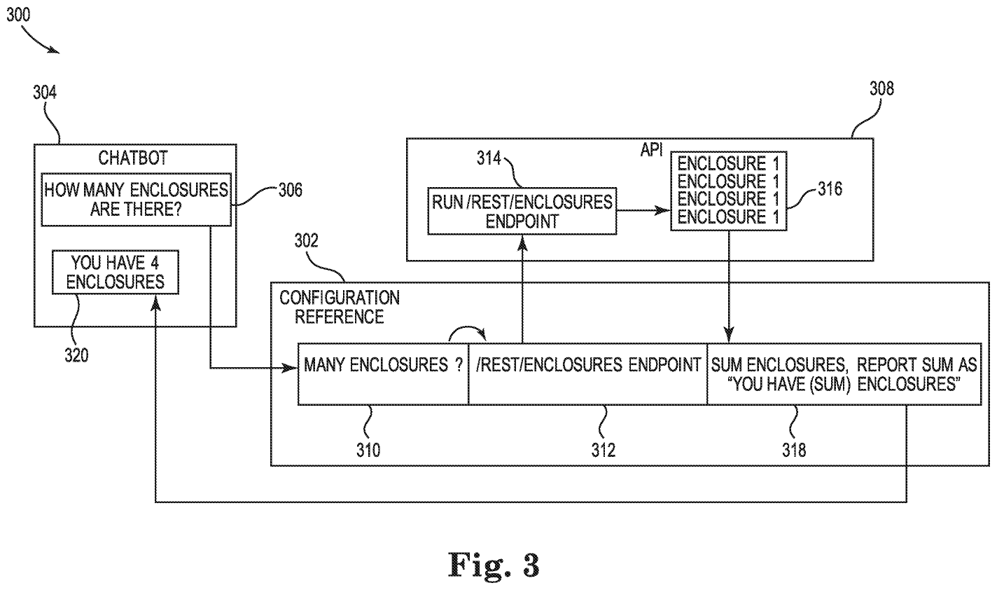

FIG. 3 illustrates an example of a system 300 implementable with API List utilization consistent with the present disclosure. The system 300 may include a chatbot 304. The chatbot 304 may be utilized as a digital assistant for interfacing with IT management APIs. The chatbot 304 may receive input an input 306 from a user.

The input 306 may include an input 306 structured in a natural language format. For example, the input 306 may include a natural language sentence including a data inquiry formatted in a natural language sentence that is directed to an API 308 that is separate from the chatbot 304. In an example, the input 306 may include the natural language sentence “HOW MANY ENCLOSURES ARE THERE?”.

The chatbot 304 may parse the configuration reference 302 of the API 308 that the input 306 is directed to. For example, the chatbot 304 may parse the configuration reference 302 of the API 308 where the data that answers the query included in the input 306 may be discovered. The chatbot 304 may parse the configuration reference 302 of the API 308 to identify a language feature identifier 310, saved in the configuration reference 302, that matches a portion of the input 306. For example, the chatbot 304 may identify that a regular expression “MANY. ENCLOSURES.?” matches the “MANY” “ENCLOSURES” and “?” characters of the natural language input 306 “HOW MANY ENCLOSURES ARE THERE?”. The chatbot 304 may identify the language feature identifier 310 as a match to the input 306.

In parsing the configuration reference 302, the chatbot 304 may identify a mapping 312 that corresponds to the language feature identifier 310 determined to match a portion of the input 306. The mapping 312 may specify a REST call corresponding to the language feature identifier 310. For example, the mapping 312 may declare an endpoint, a path, and/or an operation to be performed to the API 308. For example, the chatbot 304 may determine that the mapping 312 “RUN/REST/ENCLOSURES” endpoint corresponds to the language feature identifier 310 “MANY. ENCLOSURES.?”.

The chatbot 304 may execute the instructions declared in the mapping 312 to perform an action 314 to the API 308. For example, the chatbot 304 may perform an action 314 by executing the “RUN/REST/ENCLOSURES” endpoint of the API 308.

In executing the action 314, an output 316 may be generated through the API 308. For example, executing the “RUN/REST/ENCLOSURES” endpoint of the API 308 may generate an output 316 including a listing of the active enclosures in a data center. For example, the output 316 may include a listing of active enclosures such as “ENCLOSURE 1, ENCLOSURE 2, ENCLOSURE 3, ENCLOSURE 4” in addition to some status information about each enclosure. However, the output 316 may not be in a format that the chatbot 304 may be configured to communicate to a user.

In parsing the configuration reference 302, the chatbot 304 may identify a transformation 318 that corresponds to the mapping 312 and/or the regular expression 310 determined to match the portion of the input 306. The transformation 318 may declare instructions to transform the output 316 to a format that the chatbot 304 may utilize to communicate to the user. For example, the transformation 318 may include instructions to transform the output 316 to an approximation of a natural language response to the input 306. In an example, the transformation 318 may declare instructions to “SUM ENCLOSURES, REPORT SUM AS “YOU HAVE (SUM) ENCLOSURES”.”

The chatbot 304 may utilize the transformation 318 to transform the output 316 into a transformed output 320. For example, the chatbot 304 may sum the four enclosures reported in the output 316. The chatbot 304 may insert the sum into the natural language sentence specified in the transformation 318. The resulting transformed output 320 may read “YOU HAVE 4 ENCLOSURES.” The chatbot 304 may communicate the transformed output 320 to the user via a user interface of the chatbot 304.

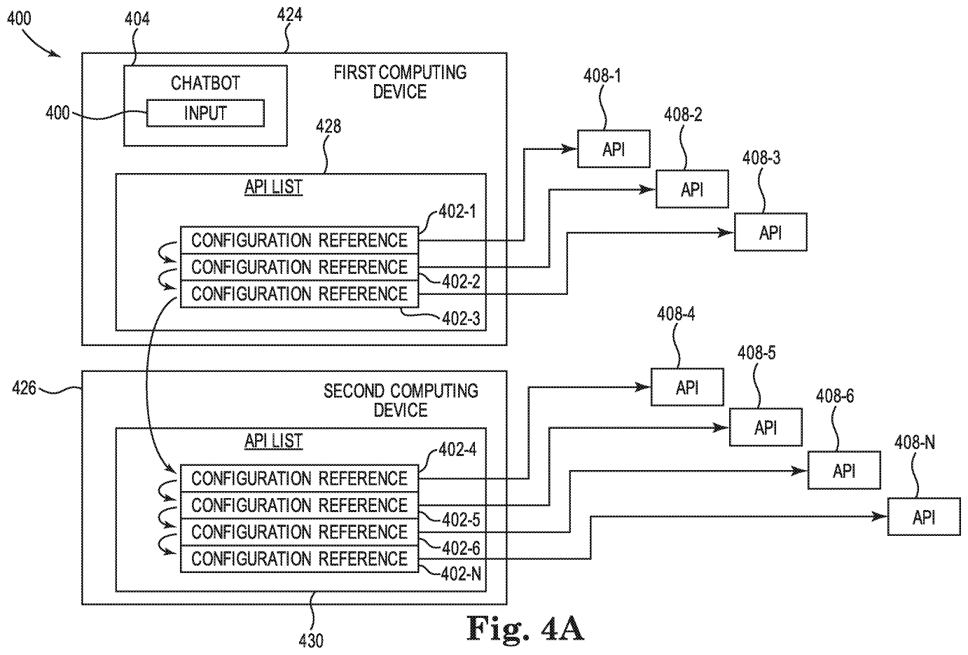

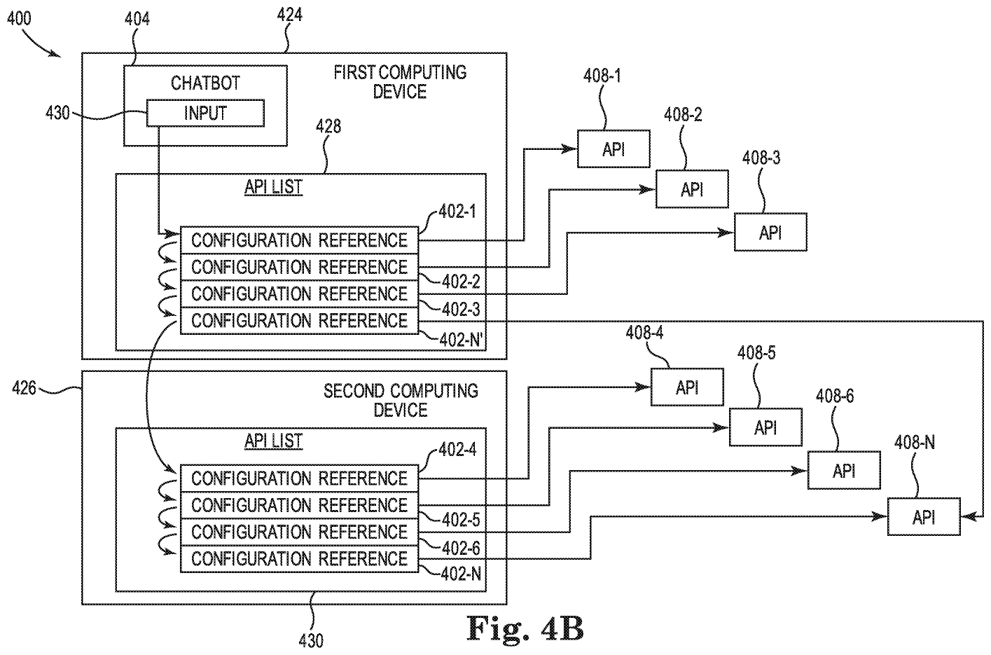

FIG. 4A illustrates an example of a system 400 of API list utilization consistent with the present disclosure. The system 400 may include a first computing device 424. The first computing device 424 may include a processor and/or a memory resource storing machine-readable instructions executable by the processor to perform functionalities described below. The computing device 424 may include a device such as a desktop computer, a laptop computer, a tablet computer, a smartphone, a smart appliance, a digital assistant, a smart home device, and internet-of-things device, a smart television, a wearable computing device, an allocation of virtualized computing resources, a computing cloud, a server, etc.

The computing device 424 may execute the instructions making up the chatbot 404. That is, the instructions providing the chatbot 404 functionality may be stored at and/or executed at the first computing device 404. Instructions, data structures, and/or connections present at the first computing device 424 may, therefore, be referred to as being local to the chatbot 404 and/or the first computing device 404 executing the chatbot 404.

The chatbot 404 may be utilized as a digital assistant for interfacing with APIs 408-1 . . . 408-N, such as IT management APIs. The chatbot 404 may receive input an input 406 from a user. The input 406 may include an input 406 structured in a natural language format. For example, the input 406 may include a natural language sentence including a data inquiry formatted in a natural language sentence that is directed to and/or supportable by an API 408-1 . . . 408-N that is separate from the chatbot 404. In an example, the input 406 may include the natural language sentence “EMAIL SALLY”.

The chatbot 404 may, responsive to receiving the input 406, search for an API among a plurality of APIs 408-1 . . . 108-N that supports the input 406. An API 408-1 . . . 408-N that supports the input 406 may include an API 408-1 . . . 408-N that has a configuration reference 401-1 . . . 402-N that includes a language feature identifier that matches a portion of the input 406 and/or that includes a mapping between the matching language feature identifier and an action at a specific API 408-1 . . . 408-N.

As such, responsive to receiving the input 406, the chatbot 404 may compare the input 406 to the language features declared in each of a plurality of configuration references 402-1 . . . 402-N in an attempt to identify a match between a portion of the input 406 and a matching language feature of a plurality of language features declared in a documentation configuration reference 402-1 . . . 402-N of each API 408-1 . . . 408-N.

However, as described above, examples of a chatbot 404 consistent with the present disclosure may be genericized with respect to its ability to interface with APIs 408-1 . . . 408-N without extending the code of the chatbot 404. As such, the chatbot 404 may be able to interface with a wide and/or nearly limitless variety of APIs 408-1 . . . 408-N so long as the configuration references 402-1 . . . 402-N of those APIs 408-1 . . . 408-N are extended to include the language feature identifier to API action mapping. Therefore, in some examples a chatbot 404 may have multiple hundreds, thousands, hundreds of thousands, millions, etc. of APIs 408-1 . . . 408-N that it may interface with. As such, any given input 406 may be potentially applicable to and/or supported by any one of the large number of APIs 408-1 . . . 408-N.

As such, iterating through and parsing each of the large number of APIs 408-1 . . . 408-N may consume vast quantities of computational resources and/or time and may lead to a decreased user satisfaction. However, the system 400 may avoid iterating through each and every documentation configuration reference 402-1 . . . 402-N of each and every of the large number of APIs 408-1 . . . 408-N each and every time an input 406 is received.

Instead, the system 400 may utilize a local API list 428 and a global API list 430. The local API list 428 may include a list of APIs 408-1 . . . 408-3 integrated locally to the computing device 424 that is executing the chatbot 404. That is, the local API list 428 may include a data structure such as a list including the configuration reference 402-1 . . . 402-3 of each of a first plurality of APIs 408-1 . . . 408-3 that is integrated locally to the computing device 424 that is executing the chatbot 404. The local API list 428 may be a list of connected APIs 408-1 . . . 408-3 that the chatbot 404 has previously connected to, utilized, and/or performed an action to. The local API list 428 may, in some examples, be a cache of configuration references 402-1 . . . 402-3 of APIs 408-1 . . . 408-3 that the chatbot 404 had previously connected to and/or utilized more than a threshold amount of times, at more than a threshold frequency, and/or more recently than a recency threshold.

The local API list 428 may store the configuration references 402-1 . . . 402-3 of the connected APIs 408-1 . . . 408-3 at a data location local to the first computing device 424. However, examples are not so limited. For example, the local API list 428 may store the configuration references 402-1 . . . 402-3 of the connected APIs 408-1 . . . 408-3 at a data location that is accessible to, although not specifically stored at the first computing device 424. That is, the computational speed increase and/or the computational time decrease associated with utilizing the local API list 428 may result not only from the local API list 428 being locally stored and/or accessible to the first computing device 424, but also from the local API list 428 providing a list of configuration references 402-1 . . . 402-3 for a smaller subset of connected APIs (e.g. APIs 408-1 . . . 408-3) rather than a global list of all the potential APIs (408-1 . . . 408-6) that may support an input 406.

The global API list 430 may include a list of APIs 408-4 . . . 408-N integrated remotely from the first computing device 424 that is executing the chatbot 404. For example, the system 400 may include a second computing device 426 that is functionally, architecturally, and/or physically separate from the first computing device 424. The second computing device 426 may include a processor and/or a memory resource storing machine-readable instructions executable by the processor to perform functionalities described below. The second computing device 426 may include a device such as a desktop computer, a laptop computer, a tablet computer, a smartphone, a smart appliance, a digital assistant, a smart home device, and internet-of-things device, a smart television, a wearable computing device, an allocation of virtualized computing resources, a computing cloud, a server, etc.

In examples, the global API list 430 may include a global API registry where a relatively larger number of and/or substantially all of the APIs 408-408-N available to interface with the chatbot have their respective configuration references 402-4 . . . 402-N listed. The global API list 430 may include the configuration references 402-4 . . . 402-N of APIs 408-4 . . . 408-N that the chatbot 404 had previously utilized and/or the configuration references 402-4 . . . 402-N of APIs 408-4 . . . 408-N that the chatbot 404 had not previously utilized. The global API list 430 may include the configuration references 402-4 . . . 402-N of APIs 408-4 . . . 408-N that have not been previously added to and/or are not still present on the local API list 428 and/or may include the configuration references 402-1 . . . 402-3 of APIs 408-1 . . . 408-3 that had been previously added to and/or are still present on the local API list 428. In some examples, the global API list 430 may include a component of an API marketplace where a large number of configuration references 402-4 . . . 402-N of APIs 408-4 . . . 408-N available to be utilized by the chatbot 404 may be stored. The global API list 430 may include substantially all of the configuration references 402-1 . . . 402-3 of APIs 408-1 . . . 408-3 in the local API list 428 and/or a large amount of additional configuration references of APIs.

As described above, the chatbot 404 may compare the input 406 to the language features declared in each of a plurality of configuration references 402-1 . . . 402-N in an attempt to identify a match between a portion of the input 406 and a matching language feature of a plurality of language features declared in a documentation configuration reference 402-1 . . . 402-N of each API 408-1 . . . 408-N. A match between a portion of the input 406 and a matching language feature of the plurality of language features declared in a particular documentation configuration reference of a particular API may indicate that the particular API supports that input 406. Further, as described above, the particular documentation configuration reference may include a mapping between the matching language feature and a particular path or action at the particular API. For example, the particular documentation configuration reference may declare a mapping between the matching language feature and an API path and an API operation corresponding to the matching language feature. For example, the particular documentation configuration reference may declare an endpoint resource exposed by the particular API and/or instructions to execute an action according to the mapping declared by the documentation configuration reference by running the API operation at the API path to cause the particular API to generate an output.

As such, responsive to receiving the input 406, the chatbot 404 may compare the input 404 to language features declared in a first documentation configuration reference 402-1 included in the local API list 428. That is, the chatbot 404 may parse the first documentation configuration reference 402-1 included in the local API list 428 for a language feature matching a language feature present in the input 406. For example, the chatbot 404 may parse the first configuration reference 402-1 in the first API list 428 for a matching language feature to any portion of the input 406 “EMAIL SALLY.”

If the chatbot 404 identifies a match between a portion of the input 406 and a language feature identifier declared in the first configuration reference 402-1 it may determine that the API 408-1 corresponding to the first configuration reference 402-1 supports the input 406. The chatbot 404 may determine a match exists between a portion of the input 406 “EMAIL SALLY” and a language feature identifier “EMAIL?” declared in the first configuration reference 402-1. That is, the action being referenced or requested in the input 406 (e.g., “EMAIL”) may be an action that the API 408-1 (e.g., an email API) corresponding to the first configuration reference 402-1 supports, recognizes, and is capable of performing.

Upon identifying a match between a portion of the input 406 and a language feature identifier declared in the first configuration reference 402-1, the chatbot 404 may identify a mapping that corresponds to the language feature identifier determined to match a portion of the input 406. The mapping may specify a REST call corresponding to the language feature identifier. For example, the mapping may declare an endpoint, a path, and/or an operation to be performed to the corresponding API 408-1. For example, the chatbot 404 may determine that the mapping “EMAIL?=>/REST/EMAIL” corresponds to the language feature identifier “Email?”.

The chatbot 404 may execute the instructions declared in the mapping to perform an action to the API 408. For example, the chatbot 404 may perform an action by executing the “RUN/REST/EMAIL” endpoint of the first API 408-1. Executing the action according to the mapping declared by the configuration reference 402-1 may include running the API operation at the API path to cause the first API 408-1 to generate an output. The chatbot 404 may additionally utilize a transformation declared in the first configuration reference 402-1 to transform the output for communication back to the user through the chatbot 404.

The chatbot 404 may discontinue parsing additional members of the local API list 428 once it has identified a match between a portion of the input 406 and a language feature identifier declared in one of the configuration references 402-1 . . . 402-3 included in the first API list 428. For example, if the chatbot 404 identifies a match between a portion of the input 406 and a language feature identifier declared in the first configuration reference 402-1, the chatbot 404 may refrain from parsing the second configuration reference 402-2 and/or the third configuration reference 402-3 in the local API list 428.

If the chatbot 404 does not identify a match between a portion of the input 406 and language feature identifiers declared in the first configuration reference 402-1 included in the local API list 428, it may determine that the first API 408-1 corresponding to the first configuration reference 402-1 does not support the input 406. As such, the chatbot 404 may begin to compare the input 406 to a next configuration reference, such as the second configuration reference 402-2 of the second API 408-2, listed in the local API list 428. If the chatbot 404 determines that there is a match between a portion of the input 406 and a language feature identifier declared in the second configuration reference 402-2 included in the local API list 428, then it may determine that the second API 408-2 supports the input 406 and may proceed with executing an action according to a mapping corresponding to the matching language identifier of the second configuration reference 402-2. As such, the chatbot 404 may refrain from parsing the third configuration reference 402-3 in the local API list 428. Following the general pattern described above, the chatbot 404 may iterate through each of the configuration references 402-1 . . . 402-3 included in the local API list 428 performing the comparison to the input until a match to the input 406 is found or until an end of the local API list 428 is reached.

In some examples, the chatbot 404 may iteratively and/or sequentially parse every configuration reference 402-1 . . . 402-3 included in the local API list 428 performing a comparison between their declared language feature identifiers and the input 406 without finding match. In such examples, the chatbot 404 may determine that the input 404 is not supported by any of the APIs 408-1 . . . 408-3 corresponding to the configuration references 402-1 . . . 402-3 included in the local API list 428.

Responsive to determining that the input 406 is not supported by any of the configuration references 402-1 . . . 402-3 listed in the local API list 428 and/or their corresponding APIs 408-1 . . . 408-3, the chatbot 404 may reference the global API list 430 integrated remotely from the first computing device 424 executing the chatbot 404. For example, responsive to determining that that the input 406 is not supported by the APIs 408-1 . . . 408-3 and/or the configuration references 402-1 . . . 402-3 listed in the local API list 428, the chatbot 404 may access the global API list 430 stored on a second computing device 426, such as a computational cloud that is separate and/or distinct from the first computing device 424.

The chatbot 404 may, responsive to determining that that the input 406 is not supported by the APIs 408-1 . . . 408-3 and/or the configuration references 402-1 . . . 402-3 listed in the local API list 428, begin to iteratively parse each of the configuration references 402-4 . . . 402-N of the APIs 408-4 . . . 408-N stored in the global API list 430 to identify a match to the input 406. For example, the chatbot 404 may compare the input 406 to the language feature identifiers declared in each of the configuration references 402-4 . . . 402-N of the APIs 408-4 . . . 408-N stored in the global API list 430. The chatbot 404 may utilize the comparison to determine whether the APIs 408-4 . . . 408-N corresponding to the configuration references 402-4 . . . 402-N stored in the global API list 430 support the input 406. The chatbot 404 may iteratively and/or sequentially compare natural language features included in the input 406 to language feature identifiers declared in each of the configuration references 402-4 . . . 402-N of the APIs 408-4 . . . 408-N stored in the global API list 430 looking for a match therebetween.

For example, the chatbot 404 may compare the input 406 to language feature identifiers declared in a fourth configuration reference 402-4 of the global API list 430 corresponding to a fourth API 408-1. If the chatbot 404 identifies a match between a portion of the input 406 and a language feature identifier declared in the first configuration reference 402-4, the chatbot 404 may determine that the fourth API 408-1 supports the input 406. As such, the chatbot 404 may identify a mapping that corresponds to the language feature identifier declared in the fourth configuration reference 402-4 and/or determined to match the portion of the input 406. The mapping may specify a REST call corresponding to the language feature identifier. For example, the mapping may declare an endpoint, a path, and/or an operation to be performed to the corresponding API 408-4. For example, the chatbot 404 may determine that a portion of the input 406 “TEXT FRED” matches the language feature identifier “TEXT?” declared in the fourth configuration reference 402-4 and that the fourth configuration reference 402-4 declares a mapping “TEXT?=>/REST/TEXT” that corresponds to the language feature identifier “TEXT?”.

The chatbot 404 may execute the instructions declared in the mapping to perform an action to the corresponding API 408-4. For example, the chatbot 404 may perform an action by executing the “RUN/REST/TEXT” endpoint of the first API 408-1. Executing the action according to the mapping declared by the configuration reference 402-4 may include running the API operation at the API path to cause the fourth API 408-4 to generate an output. The chatbot 404 may additionally utilize a transformation declared in the fourth configuration reference 402-4 to transform the output for communication back to the user through the chatbot 404.

The chatbot 404 may discontinue parsing additional members of the global API list 430 once it has identified a match between a portion of the input 406 and a language feature identifier declared in one of the configuration references 402-4 . . . 402-N included in the global API list 430. For example, if the chatbot 404 identifies a match between a portion of the input 406 and a language feature identifier declared in the fourth configuration reference 402-4, the chatbot 404 may refrain from parsing the fifth configuration reference 402-5, the sixth configuration reference 402-6, and or the Nth configuration reference 402-N in the global API list 430.

If the chatbot 404 does not identify a match between a portion of the input 406 and language feature identifiers declared in the fourth configuration reference 402-4 included in the global API list 430, it may determine that the fourth API 408-4 corresponding to the fourth configuration reference 402-4 does not support the input 406. As such, the chatbot 404 may begin to compare the input 406 to a next configuration reference, such as the fifth configuration reference 402-5 of the fifth API 408-5, listed in the global API list 430. If the chatbot 404 determines that there is a match between a portion of the input 406 and a language feature identifier declared in the fifth configuration reference 402-5 included in the global API list 430, then it may determine that the fifth API 408-5 supports the input 406 and may proceed with executing an action according to a mapping corresponding to the matching language identifier of the fifth configuration reference 402-5. As such, the chatbot 404 may refrain from parsing the sixth configuration reference 402-6 in the global API list 430. Following the general pattern described above, the chatbot 404 may iterate through each of the configuration references 402-4 . . . 402-n included in the local API list 430 performing the comparison to the input 406 until a match to the input 406 is found or until an end of the global API list 430 is reached.

In some examples, the chatbot 404 may iteratively and/or sequentially parse every configuration reference 402-4 . . . 402-N included in the global API list 430 performing a comparison between their declared language feature identifiers and the input 406 without finding match. In such examples, the chatbot 404 may determine that the input 404 is not supported by any of the APIs 408-4 . . . 408-N corresponding to the configuration references 402-4 . . . 402-N included in the global API list 430. In such examples, the chatbot 404 may communicate that no APIs were found that support the input 406 and additional input is requested.

FIG. 4B illustrates an example of a system 400 of API list utilization consistent with the present disclosure. Specifically, FIG. 4B illustrates the system 400 of FIG. 4A after a first input 408 was received and operated on by the system 400. For example, system 400 of FIG. 4A may have received an input such as “MESSAGE TOM.” The chatbot 404 of FIG. 4A may have compared the input 406 to the language features declared in the documentation configuration references 402-1 . . . 402-3 one-by-one in the order listed in the local API list 428. The chatbot 404 of FIG. 4A may have identified no matches between the input 406 and the language features declared in the documentation configuration references 402-1 . . . 402-3 listed in the local API list 428 after iterating through all of them. As such, the chatbot 404 of FIG. 4A may have determined that the input 406 was not supported by the documentation configuration references 402-1 . . . 402-3 and/or their corresponding APIs 408-1 . . . 408-3 listed in the local API list 428.

Responsive to such a determination, the chatbot 404 of FIG. 4A may have accessed the global API list 430. For example, the chatbot 404 may have compared the input 406 to the language features declared in the documentation configuration references 402-4 . . . 402-N in the order listed in the global API list 430. The chatbot 404 of FIG. 4A may have identified no matches between the input 406 and the language features declared in the fourth, fifth, and sixth documentation configuration references 402-4 . . . 402-6 listed in the global API list 430. However, upon comparing the input 406 to the Nth documentation configuration reference 402-N listed in the global API list 430, the chatbot 404 may have identified a match and discontinued parsing of further documentation configuration references.

For example, the chatbot 404 may have determined that the input “MESSAGE TOM” matches the language feature identifier “MESSAGE?” declared in the Nth configuration reference 402-N. As such, the chatbot 404 of FIG. 4A may have determined that the input 406 is supported by the Nth documentation configuration references 402-N and/or its corresponding API 408-N listed in the global API list 430. Further, the chatbot 404 may determine that the Nth configuration reference 402-N declares a mapping “MESSAGE?=>/REST/MESSAGE” to an endpoint of the Nth API 408-N that corresponds to the language feature identifier “MESSAGE?”. As such, the chatbot 404 of FIG. 4A may have determined that the input 406 is supported by the Nth documentation configuration references 402-N and/or its corresponding API 408-N listed in the global API list 430.

Responsive to the determination that the input 406 is supported by the Nth API 408-N, the chatbot 404 of FIG. 4A may add and/or cause the Nth documentation configuration reference 402-N listed in the global API list 430 to be added to the local API list 428 integrated locally to the first computing device 424 executing the chatbot 404.

FIG. 4B illustrates the result of the example operation described above for FIG. 4A. Namely, FIG. 4B illustrates a copy of the Nth configuration reference 402-N′ added from the global API list 430 to the local API list 428 of the first computing device 424 executing the chatbot 404. In this manner, by virtue of the chatbot 404 utilizing the Nth API 408-N, the Nth configuration reference 402-N′ has been automatically added to the local API list 428 integrated locally to the first computing device 424 that is executing the chatbot 404. As such, the local API list 428 may be an automatically constructed cache of utilized APIs that is automatically updated according to the utilization patterns of the chatbot 404. Since the local API list 428 is integrated locally to the first computing device 424 and the local API list will contain fewer configuration references than the global API list 430, performing the comparison of the input 430 to the configuration references listed in the local API list 428 may take less time and/or fewer comparisons to arrive at the match than the comparison of the input to the configuration references listed in the global API list 430.

As such, when the chatbot 404 receives a second input 430, the chatbot 404 may start the processes over again. For example, the chatbot 404 may receive a second input 430 such as “MESSAGE ROBERT.” The chatbot 404 may compare the natural language in the second input 430 to language feature identifiers declared in the first configuration reference 402-1 of the first API 408-1 included in the local API list 428. If no match is found in the first configuration reference 402-1 the chatbot 404 may begin comparison to the language feature identifiers declared in the second configuration reference 402-2 of the second API 408-2 stored in the local API list 428. If no match is found in the second configuration reference 402-2 the chatbot 404 may begin comparison to the language feature identifiers declared in the third configuration reference 402-3 of the third API 408-3 stored in the local API list 428. If no match is found in the third configuration reference 402-3 the chatbot 404 may begin comparison to the language feature identifiers declared in the copy of the Nth configuration reference 402-N′ of the Nth API 408-N that was previously added to the local API list 428 after the chatbot 404 had previously received an input that was found to match the Nth configuration reference 402-N of the Nth API 408-N that was stored in the global API list 430.

The chatbot 404 may determine that the input “MESSAGE ROBERT” matches the language feature identifier “MESSAGE?” declared in the copy of the Nth configuration reference 402-N′ of the Nth API 408-N stored in the local API list 428. After identifying the match between the portion of the input 430 and the copy of the Nth configuration reference 402-N′ of the Nth API 408-N stored in the local API list 428, the chatbot 404 may refrain from parsing any further configuration references of the local API list 428 and/or the global API list 430. The chatbot 404 may determine that the copy of the Nth configuration reference 402-N′ declares a mapping “MESSAGE?=>/REST/MESSAGE” to an endpoint of the Nth API 408-N that corresponds to the language feature identifier “MESSAGE?”. As such, the chatbot 404 of FIG. 4B may have determined that the input 406 is supported by the copy of the Nth documentation configuration references 402-N′ and/or its corresponding API 408-N listed in the local API list 428. The chatbot 404 may perform an action by executing the “RUN/REST/MESSAGE” endpoint of the Nth API 408-N. Executing the action according to the mapping declared by the copy of the Nth configuration reference 402-N′ may include running the API operation at the API path to cause the Nth API 408-N to generate an output. The chatbot 404 may additionally utilize a transformation declared in the copy of the Nth configuration reference 402-N′ to transform the output for communication back to the user through the chatbot 404.

In such examples, the second input 430 ultimately called on the same API 408-N that the first input 406 did. However, because the first input 406 established a relationship or connection between the chatbot 404 and the API 408-N a copy of the Nth configuration reference 402-N′ for that API 408-N was added to the local list 428. As a result, the match between the portion of the input 430 and the language feature identifier declared in the Nth configuration reference 402-N′ for that API 408-N was identified faster and with fewer computations and/or less computational cost than it would have been if the Nth configuration reference were still located exclusively in the global API list 430.

While the examples described above describe the chatbot 404 as performing the various functionalities, other examples are contemplated where the functionalities are the result of requests or commands issued by the chatbot 404 to other components. For example, a global API registry manager may manage the global API list 430. For example, a global API manager may include a set of machine-readable instructions, separate from the chatbot 404 instructions, executable by the second computing device 426 to manage requests to and/or responses from the global API list 430. In such examples, the chatbot 404 may send a request to the API registry manger to search the language features declared in the documentation configuration references, stored in the global API list 430 remotely from the first computing device 424 executing the chatbot 404, for a match to natural language features in the input 430. Additionally, the chatbot 404 may send a request to the API registry manger to report any such matches that are identified back to the chatbot 404. Furthermore, the chatbot 404 may send a request to the API registry manger to transmit the documentation configuration reference of the API containing the match to the chatbot 404 for incorporation into the local API list 428.

The local API list 428 and/or the global API list 430 may be organized and/or reorganized according to a variety of characteristics of the API and/or its utilization by the chatbot 404. For example, the local API list 428 and/or the global API list 430 may be organized and/or reorganized according to a frequency of use of the API by the chatbot 404, a recency of use of the API by the chatbot 404, a recency of addition to the list, an age of the API, a rating of the API, an advertisement associated with the API, etc. Additionally, the documentation configuration references of the APIs may be removed from one or both of the local API list 428 and/or the global API list 430 according to a variety of characteristics of the API and/or its utilization by the chatbot 404.

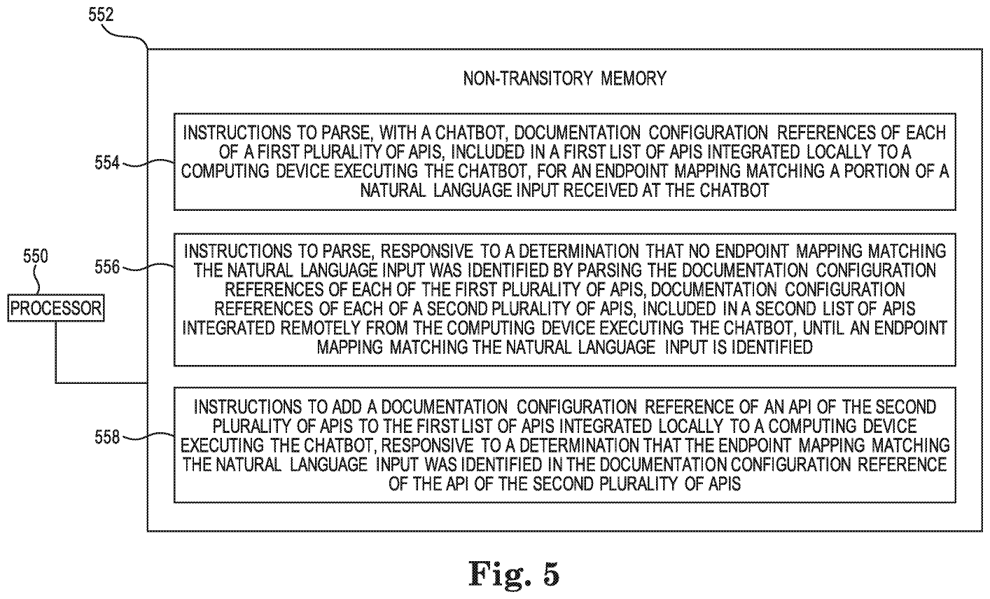

FIG. 5 illustrates an example of a non-transitory machine-readable memory resource and processing resource for API list utilization consistent with the present disclosure. The processing resource 550, and the non-transitory memory resource 552, illustrated in FIG. 5 may be analogous to the elements illustrated in FIGS. 1, 2, 3, 4A, and 4B. A memory resource, such as the non-transitory memory resource 552, may be used to store instructions (e.g., 554, 556, 558, etc.) executed by the processing resource 550 to perform the operations as described herein. The operations are not limited to a particular example described herein and may include additional operations such as those described with regard to the system 100, system 200, system 300, the system 400, and the method 680 described in connection with FIGS. 1, 2, 3, 4A, 4B, and 6.

The non-transitory memory resource 552 may store instructions 554 executable by the processing resource 550 to parse, with a chatbot, documentation configuration references of each of a first plurality of APIs. The chatbot may parse documentation configuration references of each of a first plurality of APIs that are included in a first list of APIs that is integrated locally to a computing device executing the chatbot. Parsing documentation configuration references of each of a first plurality of APIs may include searching the documentation configuration references of each of a first plurality of APIs for an endpoint mapping that matches a portion of a natural language input received at the chatbot.

For example, the chatbot may receive an input. The input may include a natural language expression requesting a digital assistant functionality. For example, the input may include a spoken and/or input text command of “EMAIL JAE.” The chatbot mat utilize this input as a comparison reference in parsing the documentation configuration references of each of a first plurality of APIs.

The chatbot may, for example, compare the natural language expression expressed in the input to language characteristics declared in the documentation configuration references of each of a first plurality of APIs. For example, the chatbot may compare the natural language expression expressed in the input to each of a plurality of language characteristics declared as supported in each of the documentation configuration references of each of a first plurality of APIs. In some examples, the chatbot may parse each of the documentation configuration references of each of a first plurality of APIs for matching regular expressions declared as supported by the correspond API. In some examples, the chatbot may analyze and/or submit for analysis the natural language component of an input to a natural language processing component to produce a human-level understanding of the natural language by a computing device and then compare that understanding to language characteristics declared as supported in each of the documentation configuration references of each of a first plurality of APIs. The chatbot may sequentially analyze each of the documentation configuration references of each of a first plurality of APIs iteratively in an order indicated by or at the first list of APIs integrated locally to a computing device executing the chatbot.

As described above, in addition to declaring language characteristics each of the language characteristics, the documentation configuration references of each of a first plurality of APIs in the first list may declare mappings between each of their declared language characteristics and an endpoint exposed by their corresponding API. The mapping may provide instructions to execute an action at the endpoint as well.

As such, by sequentially parsing each of the documentation configuration references of each of a first plurality of APIs in the first list, the chatbot may parse or cause to be parsed each of the language characteristics of each of the configuration references until an endpoint mapping matching the natural language input is identified. Once an endpoint mapping matching the natural language input is identified the chatbot may discontinue or cause to be discontinued the parsing of any additional documentation configuration references remaining unparsed in the first list. Once the endpoint mapping matching the natural language input is identified the chatbot may execute an action according to the endpoint mapping, declared by the documentation configuration reference of the API of the first plurality of APIs, matching the natural language input.

Alternatively, if an endpoint mapping matching the natural language input is not identified after parsing all of the first plurality of APIs in the first list, the chatbot may access documentation configuration references of each of a second plurality of APIs, included in a second list of APIs integrated remotely from the computing device executing the chatbot and begin sequentially parsing the second list.

The non-transitory memory resource 552 may store instructions 556 executable by the processing resource 550 to, responsive to a determination that no endpoint mapping matching the natural language input was identified by parsing the documentation configuration references of each of the first plurality of APIs in the first list, begin parsing the second list. That is, upon completing parsing of the complete first list of documentation configuration references without finding a match, the chatbot may parse and/or cause to be parsed each documentation configuration references of each of a second plurality of APIs, included in a second list of APIs. The second list of APIs may include a list of documentation configuration references and their corresponding APIs that is integrated remotely from the computing device executing the chatbot. For example, the second list may be stored on a computing cloud that is separate from a computing device where the chatbot instructions are stored and/or executed. That is, the computing device executing the chatbot instructions may establish remote access to the remote computing device where the second list is stored.

Similar to parsing the first list, the chatbot may compare the natural language expression expressed in the input to language characteristics declared in the documentation configuration references of each of the second plurality of APIs. For example, the chatbot may compare the natural language expression expressed in the input to each of a plurality of language characteristics declared as supported in each of the documentation configuration references of each of a second plurality of APIs. In some examples, the chatbot may parse each of the documentation configuration references of each of the second plurality of APIs for matching regular expressions declared as supported by the correspond API. In some examples, the chatbot may analyze and/or submit for analysis the natural language component of an input to a natural language processing component to produce a human-level understanding of the natural language by a computing device and then compare that understanding to language characteristics declared as supported in each of the documentation configuration references of each of the second plurality of APIs. The chatbot may sequentially analyze each of the documentation configuration references of each of a second plurality of APIs iteratively in an order indicated by or listed at the second list of APIs integrated remotely from the computing device executing the chatbot.

As described above, in addition to declaring language characteristics each of the language characteristics, the documentation configuration references of each of a first plurality of APIs in the first list may declare mappings between each of their declared language characteristics and an endpoint exposed by their corresponding API. The mapping may provide instructions to execute an action at the endpoint as well.

As such, by sequentially parsing each of the documentation configuration references of each of a second plurality of APIs in the second list, the chatbot may parse or cause to be parsed each of the language characteristics of each of the configuration references until an endpoint mapping matching the natural language input is identified. Once an endpoint mapping matching the natural language input is identified the chatbot may discontinue or cause to be discontinued the parsing of any additional documentation configuration references remaining unparsed in the second list. Once the endpoint mapping matching the natural language input is identified the chatbot may execute an action according to the endpoint mapping, declared by the documentation configuration reference of the API of the second plurality of APIs, matching the natural language input.

The non-transitory memory resource 552 may store instructions 558 executable by the processing resource 550 to add a documentation configuration reference of an API of the second plurality of APIs to the first list of APIs integrated locally to a computing device executing the chatbot. The documentation configuration reference may be added responsive to a determination that the endpoint mapping matching the natural language input was identified in the documentation configuration reference of the API of the second plurality of APIs. That is, configuration references found to match a portion of the input and/or utilized to identify an endpoint mapping and execute an action according to the endpoint mapping, may be copied and/or migrated to the first list from the second list. As such, the next time an input is received the documentation configuration will be encountered more rapidly as it will be parsed during the parsing of the first list.

Adding the documentation configuration reference of the API of the second plurality of APIs that matches the input to the first list of APIs may include integrating the documentation configuration reference and/or the corresponding API components to the computing device executing the chatbot. In examples, adding the documentation configuration reference of the API of the second plurality of APIs to the first list of APIs may include instructions to add a container corresponding to the API and/or the documentation configuration reference to the computing device executing the chatbot. The container may include a documentation configuration reference and/or an API that is packaged in a container architecture sitting on top of a physical server and its host operating system. The container may share the host operating system kernel and/or utilize the binaries and libraries too. The share components between the two may be read-only.

As described above, the second list may be a global API registry that includes a large number of APIs and/or their documentation configuration references. In order to reduce the amount of time and/or computational resources consumed in parsing the second list, the second list may be structured and/or organized in a manner that reduces the time and/or computational resources consumed in parsing them. For example, the documentation configuration references of each of the second plurality of APIs may be reorganized or condensed into a plurality of groups. Each group of the plurality of groups may contain more than one documentation configuration reference of an API of the second plurality of APIs. The documentation configuration references of each of the second plurality of APIs may be condensed based on language characteristics commonly declared in documentation configuration references of grouped APIs of the second plurality of APIs. That is, APIs with a same and/or similar language characteristic declared may be grouped together for the purposes of parsing and/or comparison to an input. Then, the common language characteristics of the group may be parsed to produce a computational and/or time savings. For example, each of the commonly declared language characteristics of each of the plurality of groups may be sequentially parsed through until an endpoint mapping matching the natural language input is identified in the commonly declared language characteristics of a group of the plurality of groups.

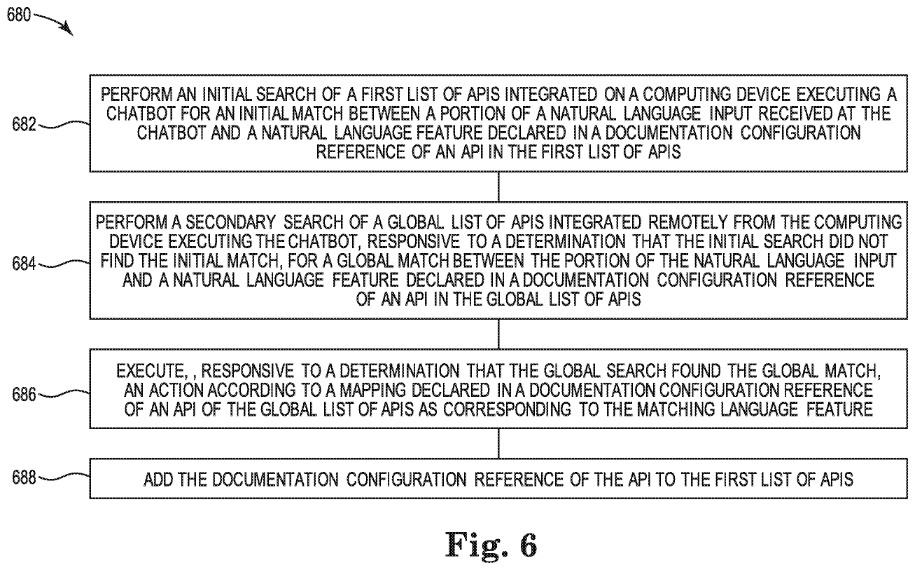

FIG. 6 illustrates an example of a method 680 for API list utilization consistent with the present disclosure. The method 680 may incorporate elements of and/or be utilized by the system 100, the system 200, the system 300, the system 400, and/or the non-transitory memory 552 of FIGS. 1, 2, 3, 4A, 4B, and 5.

At 682, the method 680 may include performing an initial search of a first list of APIs integrated on a computing device executing a chatbot. The first list of APIs may be searched for an initial match between a portion of a natural language input received at the chatbot and a natural language feature declared in a documentation configuration reference of an API in the first list of APIs.

The first list of APIs may be searched by comparing a portion of the natural language input to natural language features declared in each documentation configuration reference of each API in the API list. If a match is found, then the remaining configuration references in the API list may not be parsed and an action to the API may be executed according to a mapping between the declared natural language features, a path, and/or an action declared in the documentation configuration reference that matches the portion of the input. Alternatively, if the initial search does not find an initial match and/or all the APIs in the first API list are parsed, then a secondary search may be initiated.

At 684, the method 680 may include performing a secondary search of a global list of APIs integrated remotely from the computing device executing the chatbot. The secondary search of the global list may be initiated responsive to a determination that the initial search did not find the initial match. The global list may be searched for a global match between the portion of the natural language input and a natural language feature declared in a documentation configuration reference of an API in the global list of APIs.

The global list of APIs may be searched by comparing a portion of the natural language input to natural language features declared in each documentation configuration reference of each API in the global API list. If a match is found, then the remaining configuration references in the global API list may not be parsed.

As described above, the documentation configuration references may declare mappings between declared natural language features, API paths, API endpoints, and/or API actions.

At 686, the method 680 may include executing an action to the API.

For example, responsive to a determination that the global search found the global match, an action may be executed according to a mapping declared in a documentation configuration reference of an API of the global list of APIs as corresponding to the matching language feature.

At 688, the method 680 may include adding the documentation configuration reference of the API to the first list of APIs. That is, the documentation configuration reference of the API that includes the language feature that matches the portion of the input may be moved and/or copied to the computing device executing the chatbot. As such, when a subsequent natural language input is received at the chatbot, the first list may be searched for a match prior to searching the global list for the match. When the subsequent natural language input matches the documentation configuration reference added to the first list, that match will be identified more rapidly since the first list is searched prior to searching the global list.

As described above, the documentation configuration references may also declare transformations corresponding to declared natural language features, API paths, API endpoints, and/or API actions. The transformation that corresponds to the natural language feature may include instructions to transform an output, resulting from executing the action, to a transformed output reformatted for communication by the chatbot to a user issuing the input. As such, an output of the API that is generate in response to executing the action may be transformed to a format declared in the documentation configuration reference of the API as corresponding to the matching language feature.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

As used herein, the designator “N”, particularly with respect to reference numerals in the drawings, indicates that a plurality of the particular feature so designated can be included with examples of the disclosure. The designators can represent the same or different numbers of the particular features. Further, as used herein, “a plurality of” an element and/or feature can refer to more than one of such elements and/or features.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

What is claimed:

1. A system, comprising:
a processing resource;
a memory resource storing machine-readable instructions to cause the processing resource to:
compare an input, received at a chatbot, to language features declared in a documentation configuration reference of a first application programming interface (API), in a first list of APIs integrated locally to a computing device executing the chatbot, to determine whether the first API supports the input;
compare, responsive to a determination that the input is not supported by the first API, the input to language features declared in a documentation configuration reference of a second API, in a second list of APIs integrated remotely from the computing device executing the chatbot, to determine whether the second API supports the input; and
add, responsive to a determination that the input is supported by the second API, the documentation configuration reference of the second API to the first list of APIs integrated locally to the computing device executing the chatbot.

2. The system of claim 1, wherein the language features declared in the documentation configuration reference of the first API and the language features declared in the documentation configuration reference of the second API include regular expressions.

3. The system of claim 1, wherein the documentation configuration reference of the first API declares the structure of the first API and the documentation configuration reference of the second API declares the structure of the second API.

4. The system of claim 1, including instructions to determine that the input is supported by the second API by identifying a match between a portion of the input and a matching language feature of the plurality of language features declared in the documentation configuration reference of the second API.

5. The system of claim 4, wherein the documentation configuration reference of a second API declares a mapping of an API path and an API operation corresponding to the matching language feature declared in the documentation configuration reference of the second API.

6. The system of claim 5, wherein the API path includes an endpoint resource exposed by the second API.

7. The system of claim 5, including instructions to execute an action according to the mapping declared by the documentation configuration reference of a second API by running the API operation at the API path to cause the second API to generate an output.

8. The system of claim 1, including instructions to compare a second input, received after the addition of the documentation configuration reference of the second API to the first list of APIs, to language features declared in a documentation configuration reference of a first API and to language features declared in a documentation configuration reference of a second API prior to comparing the second input to a documentation configuration reference of a third API, in the second list of APIs.

9. The system of claim 1, including instructions to compare the language features declared in the documentation configuration reference of the first API to the input by parsing, with the chatbot, each of the language features declared in the documentation configuration reference of the first API, stored at the computing device executing the chatbot, for a match to natural language in the input.

10. The system of claim 9, including instructions to compare the language features declared in the documentation configuration references of the second API to the input by parsing, with the chatbot, each of the language features declared the documentation configuration references of the second API, stored remotely from the computing device executing the chatbot, for a match to natural language in the input.

11. The system of claim 9, including instructions to submit a request, from the chatbot to a global API registry manager, to:
search the language features declared in the documentation configuration references of the second API, stored remotely from the computing device executing the chatbot, for a match to natural language in the input;
report the match to the chatbot; and
transmit the documentation configuration reference of the second API containing the match to the chatbot.

12. A non-transitory machine-readable storage medium having stored thereon machine-readable instructions to cause a computer processor to:
parse, with a chatbot, documentation configuration references of each of a first plurality of application programming interfaces (APIs), included in a first list of APIs integrated locally to a computing device executing the chatbot, for an endpoint mapping matching a portion of a natural language input received at the chatbot;
parse, responsive to a determination that no endpoint mapping matching the natural language input was identified by parsing the documentation configuration references of each of the first plurality of APIs, documentation configuration references of each of a second plurality of APIs, included in a second list of APIs integrated remotely from the computing device executing the chatbot, until an endpoint mapping matching the natural language input is identified; and
add a documentation configuration reference of an API of the second plurality of APIs to the first list of APIs integrated locally to a computing device executing the chatbot, responsive to a determination that the endpoint mapping matching the natural language input was identified in the documentation configuration reference of the API of the second plurality of APIs.

13. The non-transitory machine-readable medium of claim 12, including instructions to execute an action according to the endpoint mapping, declared by the documentation configuration reference of the API of the second plurality of APIs, matching the natural language input.

14. The non-transitory machine-readable medium of claim 12, wherein the instructions to add the documentation configuration reference of the API of the second plurality of APIs to the first list of APIs includes instructions to add a container corresponding to the API to the computing device executing the chatbot.

15. The non-transitory machine-readable medium of claim 12, wherein the instructions to parse documentation configuration references of each of a second plurality of APIs until an endpoint mapping matching the natural language input is identified includes instructions to sequentially parse through each of the documentation configuration references of each of a second plurality of APIs in an order specified by the second list of APIs until an endpoint mapping matching the natural language input is identified.

16. The non-transitory machine-readable medium of claim 12, including condensing the documentation configuration references of each of a second plurality of APIs into a plurality of groups, each group of the plurality of groups containing more than one documentation configuration reference of an API of the second plurality of APIs, based on language characteristics commonly declared in documentation configuration references of grouped APIs of the second plurality of APIs.

17. The non-transitory machine-readable medium of claim 16, wherein the instructions to parse documentation configuration references of each of a second plurality of APIs until an endpoint mapping matching the natural language input is identified includes instructions to sequentially parse through each of the commonly declared language characteristics of each of the plurality of groups until an endpoint mapping matching the natural language input is identified in commonly declared language characteristics of a group of the plurality of groups.

18. A method, comprising:
performing an initial search of a first list of application programming interfaces (APIs) integrated on a computing device executing a chatbot for an initial match between a portion of a natural language input received at the chatbot and a natural language feature declared in a documentation configuration reference of an API in the first list of APIs;
performing a secondary search of a global list of APIs integrated remotely from the computing device executing the chatbot, responsive to a determination that the initial search did not find the initial match, for a global match between the portion of the natural language input and a natural language feature declared in a documentation configuration reference of an API in the global list of APIs;
executing, responsive to a determination that the global search found the global match, an action according to a mapping declared in a documentation configuration reference of an API of the global list of APIs as corresponding to the matching language feature; and
adding the documentation configuration reference of the API to the first list of APIs.

19. The method of claim 18, including transforming, by the chatbot, an output of the API, generated in response to executing the action, to a format declared in the documentation configuration reference of the API as corresponding to the matching language feature.

20. The method of claim 1, including searching the first list prior to searching a global list for a match to a subsequent natural language input at the chatbot.
